(19) United States
(12) Patent Application Publication
(10) Pub. No.: US 2026/0249516 A1
(43) Pub. Date: Aug. 27, 2026

(54) U-SHAPED CUTTING SEGMENTS FOR ABRASIVE CUTTING TOOLS

(71) Applicant: HUSQVARNA AB, Huskvarna (SE)

(72) Inventors: Brianna Jena Alma WELCH, Columbia, SC (US); Kevin Jerome SMITH, Jr., Lexington, SC (US); Philippe UYTTERS, Wezembeek-Oppem (BE)

(21) Appl. No.: 18/874,774

(22) PCT Filed: Jun. 20, 2022
(86) PCT No.: PCT/US2022/034133

§ 371 Date: Dec. 13, 2024

(51) Int. Cl. B28D 1/12; B24D 7/06

(52) U.S. Cl. CPC B28D 1/122; B24D 7/06

(57) ABSTRACT

A cutting segment (110) for mounting onto a work tool to provide an abrasive operation by the work tool, the cutting segment (110) having first and second side walls (220, 230) extending in an intended direction of motion (M) of the cutting segment (110) during the abrasive operation by the work tool, wherein the side walls (220, 230) are joined by a top surface (210) arranged to engage a work object during the abrasive operation, and where a pre-formed groove (130) in the top surface (210) of the cutting segment (110) extends in the intended direction of motion (M).

### TECHNICAL FIELD

The present disclosure relates to abrasive cutting tools for processing hard materials such as concrete, reinforced concrete, and stone. There are disclosed cutting segments and work tools comprising the cutting segments, as well as related construction equipment.

### BACKGROUND

It is known to use abrasive tools for cutting hard materials such as concrete, reinforced concrete and stone. Abrasive tools normally comprise cutting segments arranged on the periphery of a rotatable work tool which engages the material to be cut.

There is a need for cutting segments that make the cutting operation more efficient.

### SUMMARY

It is an object of the present disclosure to provide improved cutting segments, saw blades and other work tools for cutting hard materials such as reinforced concrete and stone.

This object is at least in part obtained by a cutting segment for mounting onto a work tool to provide an abrasive operation by the work tool. The cutting segment has first and second opposing side walls extending in an intended direction of motion of the cutting segment during the abrasive operation by the work tool. The cutting segment also has a top surface that is arranged to engage a work object during the abrasive operation, which top surface joins the two side walls. A groove which extends in the intended direction of motion has been pre-formed in the top surface of the cutting segment. First and second gable portions extend transversally to the side walls and to the top surface. Thus, the cutting segment is delimited by two opposing side walls, two opposing gable portions, and by the top surface opposite to the work tool.

The groove is an elongated indentation formed in the top surface during manufacturing of the cutting segment. This pre-formed groove in the top surface has been shown to increase the cutting efficiency of the cutting segment. The increase in efficiency may at least in part be due to that the cutting segment now engages the work object like two parallel knives which cuts into the work object, while to bottom portion of the groove efficiently transports away abraded material from the cut. The depth of the pre-formed groove, measured in a direction normal to the bottom surface of the groove is at least 0.75 mm, and preferably more than 1.0 mm, at least in one place along the groove. Thus, the pre-formed groove is of substantial depth, beyond a depth obtainable by mere wear on known sandwich material cutting segments. By pre-forming the groove in the top surface, improved cutting efficiency is obtained already at the start of use of a new cutting segment, which is an advantage. The cutting segment preferably comprises diamond granules held fixedly in position by a bonding matrix, but other forms of abrasive materials can also be used, such as various carbides.

The groove is pre-formed in the sense that it exists already when the cutting segment leaves the factory and before the cutting segment has been used for the first time. The pre-formed groove can, e.g., be a machined groove, a molded groove, or a pressed groove.

The pre-formed groove has longitudinal side walls extending in the intended direction of motion, i.e., in the same direction as the cutting segment side walls. These longitudinal side walls of the pre-formed groove are preferably arranged at an angle relative to the respective side wall of the cutting segment. Consequently, the groove is preferably not perfectly rectangular in its cross-section shape, but has side walls which slope inwards and downwards into the groove, making the groove narrower at the bottom compared to at the top of the groove. Due to these angled walls lateral pressure is applied to the sides of the groove during groove formation by a pressing tool, such as the graphite pressing tool which will be discussed in more detail below. The lateral pressure on the side walls increases the strength of the side walls, which is an advantage. The angle is preferably between 30 degrees and 70 degrees, and more preferably about 56 degrees.

A width of the pre-formed groove measured orthogonally to the intended direction of motion preferably decreases from between 3.3-4.3 mm, and more preferably from 3.8 mm, at the top of the pre-formed groove to somewhere between 0.5-1.5 mm, and more preferably 1.0 mm, at the bottom of the pre-formed groove. The exact width of the pre-formed groove can of course be optimized in dependence of the intended cutting operation and can therefore vary, but these width specifications have been found suitable for a number of work tasks, such as floor sawing and wall sawing.

A ratio of the largest width of the pre-formed groove and a total width the cutting segment is between 70% and 90%, and preferably about 80%. Thus, the groove forms a rather large part of the top surface.

A ratio of the largest depth of the pre-formed groove and the largest width of the pre-formed groove is between 30% and 50%, and preferably about 40%. Thus, the groove is preferably more wide than deep, although some applications may merit from other width to depth relationships. Similarly, a ratio of the largest depth of the pre-formed groove and the largest width of the total cutting segment is between 20% and 40%, and preferably about 30%.

The segment is advantageously formed in at least three layers extending in the general direction of the side walls, i.e., in the intended direction of motion and transversal to the top surface. This means that the cutting segment is of a sandwiched structure, formed in different layers separated by planes extending in the general direction of the side walls. The side layers, forming at least part of the side walls, comprise abrasive particles of a finer grit size compared to one or more layers interleaved between the side layers, which is an advantage from a cutting efficiency point of view. The abrasive particle grit size of the abrasive particles in the side layers preferably corresponds to a mesh size of 40/45, while the abrasive particle grit size of the abrasive particles in a layer interleaved between the side layers corresponds to a mesh size of 35/40, i.e., slightly larger compared to the outer layers forming the groove side walls.

According to some other preferred aspects, the side layers (forming at least part of the side walls) also comprise abrasive particles in a higher concentration compared to one or more layers interleaved between the side layers. This means that there are more contact points between diamond and work object at the side wall parts of the top surface compared to in the groove part of the top surface. This feature improves cutting efficiency. The volume percentage of abrasive particle concentration in the side layers is suitably selected to be between 12.5-13.5% and preferably around 12.9%. The volume percentage of abrasive particle concentration in one or more layers interleaved between the side layers is suitably selected to be between 11.5-12.5% and preferably 12.0%. Also, since the side walls are more durable compared to the center portion of the cutting segment, the groove shape is maintained during use. I.e., since the groove bottom portion wears faster than the groove walls, the groove is maintained even though the cutting segment top surface is worn down during use.

According to some aspects, the largest width of the pre-formed groove is smaller than the width of the cutting segment by an amount, to form top surface side portions on either side of the pre-formed groove. The top surface side portions are of arcuate form seen in direction of a side wall, while the bottom surface of the groove is a flat surface. This means that the groove is deeper at the middle compared to at the ends of the groove, and that the groove side walls are higher in the middle compared to at the ends of the groove. Consequently, the groove side walls at the ends of the cutting segment, which impact the work object and are often subject to more wear, and a bit stronger due to the smaller groove wall height. The top surface side portions are akin to parallel knives slicing into the work object, as discussed above.

Saw blades and other rotatable work tools associated with the above-mentioned advantages are also disclosed herein, as well as groove formation tools and production methods for manufacturing the cutting segment.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIG. 1 shows an example saw blade comprising cutting segments;

FIG. 2 shows a cutting segment according to a first example;

FIGS. 3A-B illustrate views of an example cutting segment;

FIG. 4 illustrates a cutting segment geometry and sandwich structure;

FIGS. 5A-B show a process of producing a cutting segment;

FIGS. 6A-B illustrate an example cold press die;

FIGS. 7A-C show different views of an example groove formation tool;

FIG. 8 is a flow chart illustrating a production method; and

FIGS. 9-14 illustrate example construction equipment.

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims. This applies in particular to the example dimensions of the cutting segments and the saw blades described below.

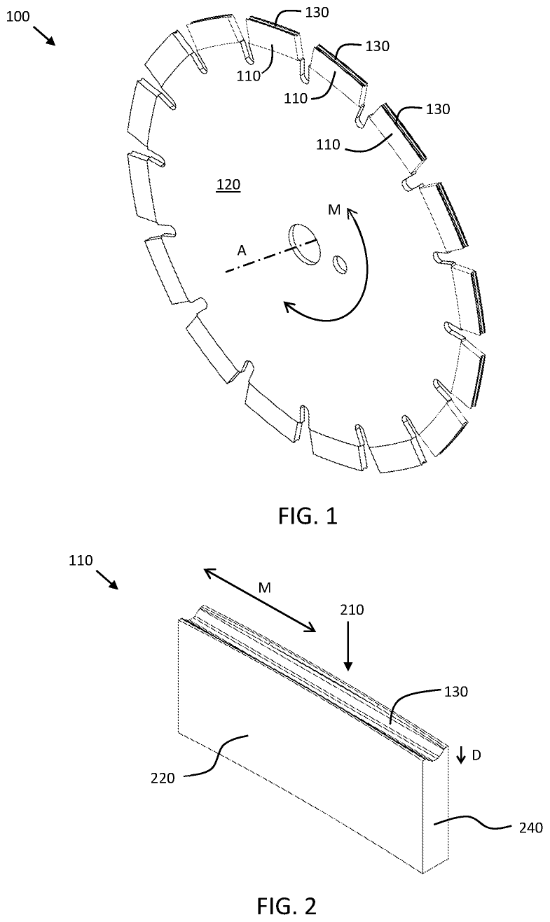

FIG. 1 illustrates an example abrasive saw blade 100. The saw blade 100 comprises a number of abrasive cutting segments 110 arranged along a peripheral edge of the saw blade in a known manner. The saw blade is an example of a rotatable work tool having an intended direction of motion M about an axis of rotation A.

Generally herein, dimensions will be given in millimeters (mm) and weights will be given in carats (cts) or in grams (g). It is appreciated that the provided dimensions in the drawings and in the text are purely by way of example in order to illustrate how the disclosed cutting segments and saw blades may be realized in practice.

The cutting segment 110 comprises abrasive granules, such as diamond particles, held fixedly in position by a metal matrix. It is desired to provide cutting segments which promote cutting efficiency while at the same time resisting excessive tool wear, i.e., cutting segments which cut well, and which last for a long time.

U.S. Pat. No. 3,028,710 discloses cutting segments that are manufactured in a sandwich structure where the outer side wall layers of the cutting segment comprise a higher concentration of abrasive particles compared to the center portion in-between the side wall layers. This means that the center portion wears faster compared to the side wall portions, resulting in a concave cutting segment surface which has been shown to promote cutting efficiency.

ES2762970 also describes cutting segments of a sandwich design, where a concave wear of the cutting segment surface is promoted by using different material compositions in different layers of the cutting segment.

Due to the sandwich structure of the cutting segments according to the above-mentioned prior art, a small indentation is formed in the top surface during use which promotes cutting efficiency. This indentation, or groove, extends in the intended direction of motion M of the cutting segments. It has been realized that further improvements can be obtained by pre-forming this groove, and also making it more pronounced, i.e., deeper and with more distinct groove walls.

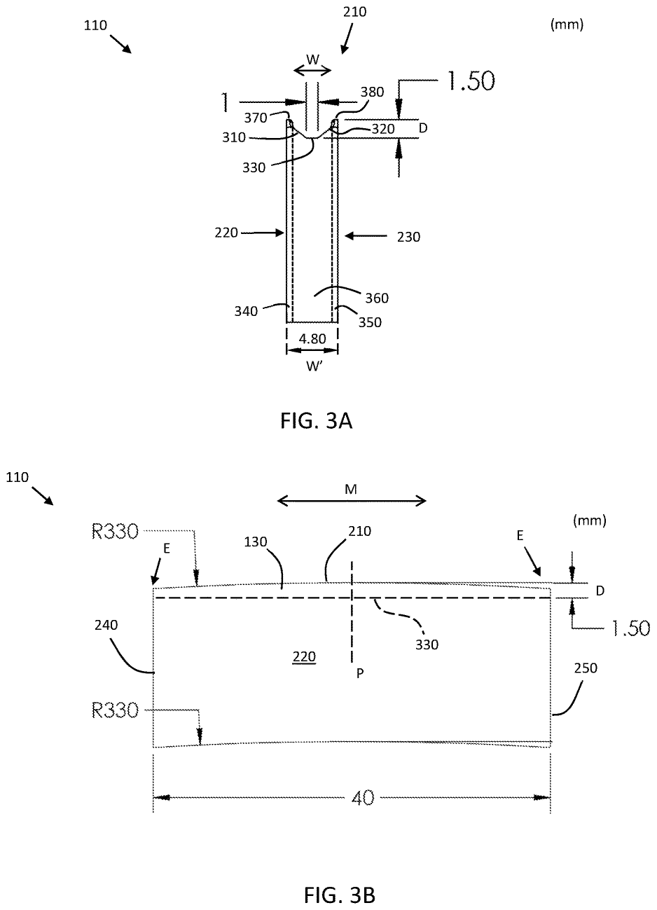

FIG. 2 shows a perspective view of an example cutting segment 110 and FIGS. 3A-B show side views of the example cutting segment 110. Each cutting segment 110 on the work tool has first and second opposing side walls 220, 230 extending in the intended direction of motion M of the cutting segment 110 during the abrasive operation by the work tool. The side walls are normally parallel to each other. Each segment also has two opposing gable portions 240, 250 extending transversally to the side surfaces and also transversally to a top surface 210 of the cutting segment. The top surface 210 joins the side walls of the cutting segment and faces the object to be cut. It is, in other words, the top surface 210 that engages the material to be cut during the abrasive operation. On a saw blade such as the work tool 100, the side walls 220, 230 of the cutting segment 110 extend in the saw blade plane, while the gable portions 240, 250 extend along a direction normal to the saw blade plane, i.e., along the axis of rotation A of the saw blade. The top surface 210 of the cutting segment extends along the saw blade periphery on the example work tool 100 in FIG. 1.

The cutting segment 110 normally comprises diamond granules held fixedly in position by a bonding matrix. However, other abrasive materials can also be used, such as carbide granules.

A groove 130 is pre-formed in the top surface 210 of the cutting segment 110, where it extends in the intended direction of motion M. The pre-formed groove is an elongated indentation formed in the top surface. This pre-formed groove 130 is different from the concave top surface shapes that result from wear of the cutting segments described in U.S. Pat. No. 3,028,710 and in ES2762970, where the groove-like shapes are not pre-formed but result from use of the tool. By pre-forming the groove in the top surface, improved cutting efficiency is obtained already at the start of use of a new cutting segment, which is an advantage. Also, the pre-formed groove can be formed with arbitrarily large depth D and with an optimized shape and overall geometry of the groove. The pre-formed groove 130 can be formed by different techniques, e.g., as a milled or machined groove, a molded groove formed by molding of the cutting segment, or a pressed groove formed by a cold press or hot press technique.

A depth D of the pre-formed groove 130 measured in a direction normal to the bottom surface 330 of the groove 130, as illustrated in FIG. 3A and in FIG. 3B, may be at least 0.75 mm, and is preferably more than 1.0 mm at least in one place along the groove 130. In the example cutting segment illustrated in FIGS. 3A and 3B, the depth of the groove 130 at the mid-point P of the cutting segment is about 1.5 mm, which has been found to be a suitable depth of the groove 130 for a cutting segment having the dimensions indicated in FIG. 3A and in FIG. 3B.

Note that the top surface 210 has a radius R330, which is preferably selected to be similar to the radius of the work tool, i.e., to follow the periphery of the saw blade 100, while the bottom surface of the groove 330 is flat, which means that the groove depth is larger at the midpoint M compared to at the end points E of the groove 130. This radius is optional, and preferably not used if the cutting segment is intended for a core drill bit or other type of work tool not having a saw blade shape. In the examples, the depth of the groove at the end points E of the groove 130 is about 0.89 mm. An effect of this depth variation of the groove is that the groove walls, being smaller at the end points E, are stronger compared to at the midpoint M. The mechanical stress at the endpoints E is normally larger compared to at the midpoint, since the endpoints sometimes strike the object to be cut.

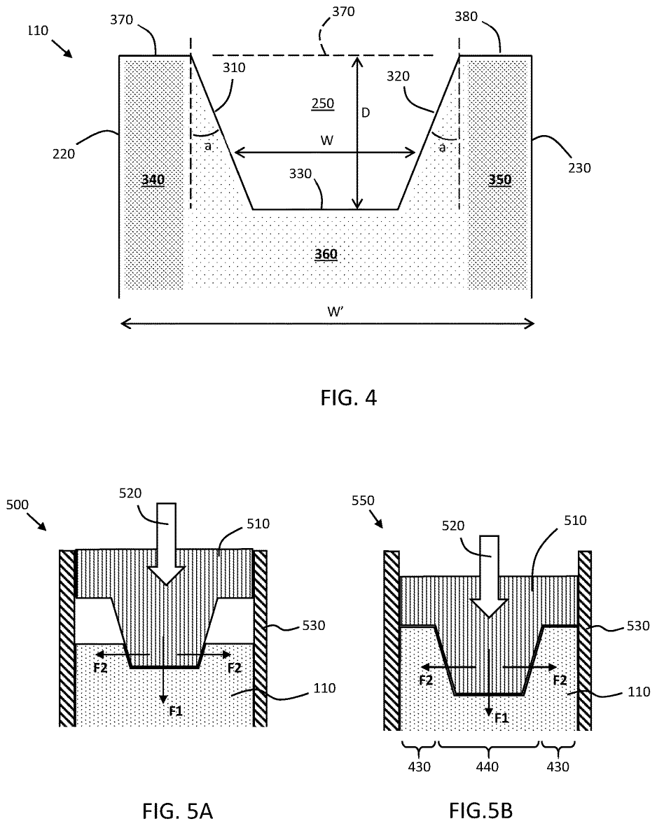

The pre-formed groove 130 preferably has longitudinal side walls 310, 320 extending in the intended direction of motion M which are arranged at an angle α relative to the respective side wall 220, 230 of the cutting segment 110, as shown in FIG. 4. This angle a has an interesting technical effect which is schematically illustrated 500, 550 in FIGS. 5A and 5B. If the pre-formed groove 130 is manufactured by pressing a groove formation tool 510 into the cutting segment 110 to generate a force F1, as illustrated in FIG. 5A by the arrow 520, then the cutting segment material is also pressed laterally out towards the side walls of the tool 530 by the force F2. This means that the side walls of the groove become stronger because of the angle a, and therefore better able to resist wear during the abrasive operation. The angle a can be configured between 30 degrees and 70 degrees, and preferably about 56 degrees.

It has been found that the groove geometry has an impact on the cutting performance of the tool 100. The groove 130 essentially forms two narrow cutting portions 370, 380 resembling knives, which cut into the work object with less effort compared to if the entire top surface of the cutting segment had been flat. The top surface side portions 370, 380 are preferably formed with a small width, but not too small to loose mechanical integrity of the groove walls. The width W of the groove at the bottom surface 330 and at the top are parameters of interest, as well as the depth D of the groove and the overall width W′ of the cutting segment 110.

One example geometry which has been found to give good results in terms of cutting efficiency and cutting segment wear is a cutting segment 110 where the width W of the pre-formed groove 130 measured orthogonally to the intended direction of motion M decreases from between 3.3 mm and 4.3 mm and preferably 3.8 mm at the top of the pre-formed groove 130 to between 0.5 mm and 1.5 mm and preferably 1.0 mm at the bottom of the pre-formed groove 130.

The dimensions of the example in the drawings has an upper groove width of 3.8 mm and a total cutting segment width of 4.8 mm, i.e., the side portions are each 0.5 mm wide. Generally, a ratio of the largest width W of the pre-formed groove 130 and a width W′ the cutting segment 110 is between 70% and 90%, and preferably about 80% as in the examples shown in the drawings.

The depth of the groove at the deepest point (around the midpoint M of the groove), is 1.5 mm in the examples, while the largest width W of the pre-formed groove 130 (at the top of the groove) is about 3.8 mm. Generally, the ratio of the largest depth D of the pre-formed groove 130 and the largest width W of the pre-formed groove 130 is between 30% and 50%, and preferably about 40%. A ratio of the largest depth D of the pre-formed groove 130 and the largest width W of the pre-formed groove 130 is between 20% and 40%, and preferably about 30%.

FIG. 4 shows an example cutting segment 110 having a layered structure, commonly referred to as a sandwich structure. The segment is formed in three layers 340, 350, 360 extending in direction of the side walls 220, 230, i.e., in the intended direction of motion M and transversal to the top surface 210. The side layers 340, 350 that form the side walls 220, 230 of the cutting segment 110 preferably comprise abrasive particles of a finer grit size compared to one or more layers 360 interleaved between the side layers 340, 350. The abrasive particle composition in these layers can be optimized to promote cutting efficiency and wear characteristics of the cutting segment 110.

Various metrics can be used to define diamond granule size. The mesh size of the diamond granules in an abrasive cutting segment refers to the average number of openings in a filter screen of standard size. The larger the number, the smaller the opening. A mesh size of 40/45 corresponds to particle size of approximately 413 microns. A mesh size of 35/40 is approximately 456 microns, where the micron measures can be the dimension of a bounding box which is able to enclose a majority of the abrasive particles. Other definitions can of course be used, and these values are to be construed as guidelines and not exact specifications. The abrasive particle grit size of the abrasive particles in the side layers may correspond to a mesh size of about 40/45 (about 413 microns), and the abrasive particle grit size of the abrasive particles in the layer 360 interleaved between the side layers 340, 350 may correspond to a mesh size of about 35/40 (about 456 microns), i.e., a more coarse grit compared to the side layers. The finer grit in the side layers provide more contact points between the hard abrasive particles and the work object, which is an advantage.

Abrasive particle concentration, e.g., diamond granule concentration, in an abrasive cutting segment can be defined in various ways, such as in terms of carats (cts) per cubic cm (cm3), in terms of gr/cm3, or in terms of a volume percentage of abrasive particles in relation to the total cutting segment volume. The Federation of European Producers of Abrasives (FEPA) also defines a standard for abrasive particle concentration. The table below provides some illustrative relationships between different units of concentration.

| Cts/cm3 | gr/cm3 | Volume | | FEPA C con |
|---|---|---|---|---|
| 2.124 | 0.4248 | 12.00% | Standard | 48.0 |
| 2.218 | 0.4435 | 12.53% | | 50.1 |
| 2.288 | 0.4576 | 12.93% | Standard | 51.7 |
| 2.478 | 0.4956 | 14.00% | | 56.0 |
| 2.650 | 0.5300 | 14.97% | Standard | 59.9 |

The side layers 340, 350 forming the side walls 220, 230 may comprise abrasive particles in a higher concentration compared to one or more layers 360 interleaved between the side layers 340, 350, to promote strength in the groove walls and in the side portions 370, 380. The volume percentage of abrasive particle concentration in the side layers 340, 350 is suitably selected to be between 12.5-13.5% and preferably around 12.9%. The volume percentage of abrasive particle concentration in one or more layers 360 interleaved between the side layers 340, 350 is suitably selected to be between 11.5-12.5% and preferably 12.0%.

Generally, the advantages in cutting efficiency discussed herein are obtained if the side layers 340, 350 forming the side walls 220, 230 comprise abrasive particles in a volume concentration that is at least 1.1 times higher than a volume concentration in one other layer, such as the middle layer 360, and preferably more than 1.7 times higher.

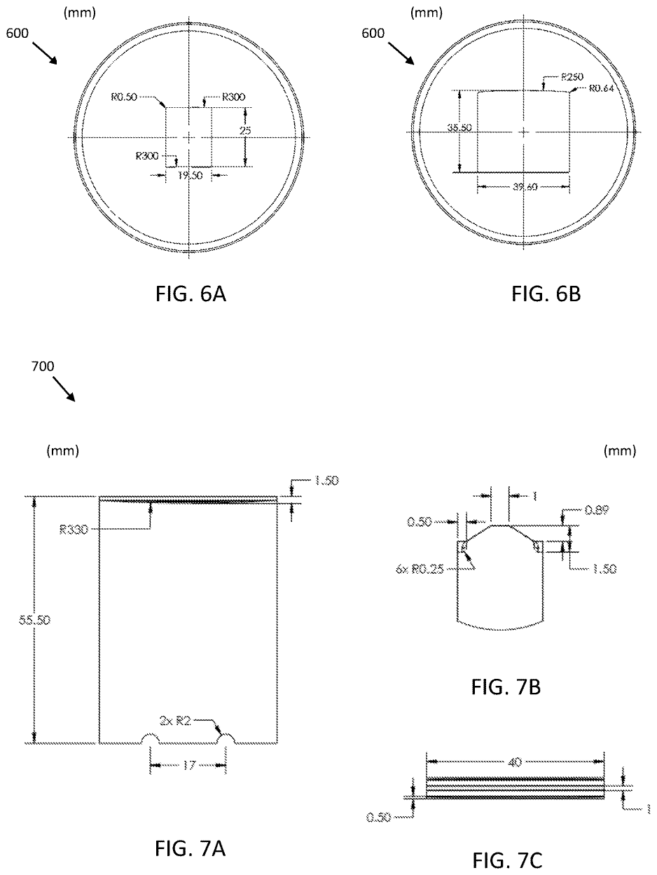

Generally, the side layers 340, 350 forming the side walls 220, 230 preferably also comprise abrasive particles of at least 5 mesh finer grit compared to one other layer. FIGS. 6A and 6B illustrate example cold press dies which are used to form the initial cutting segment blank prior to formation of the groove 130 in the cutting segment 110 by a groove formation tool. It is noted that cutting segments of varying dimension can be formed in the manner described herein. Some forms of work tools comprise smaller cutting segments while other types of work tools have larger cutting segments. The geometry of the groove in relation to the overall geometry of the cutting tool can be adapted in a straight-forward manner, e.g., using practical experimentation or computer simulation.

FIGS. 7A and 7B illustrate a groove formation tool 700 which can be used with advantage to pre-form the groove 130 in the cutting segment blank obtained from the cold press die 600. This groove formation tool 700 can be formed in graphite or in some other suitable material. The dimensions of the groove formation tool 700 essentially mirror the dimensions of the groove illustrated in FIGS. 3A and 3B. Preferably, the groove formation tool comprises a wedge shape, although other shapes are conceivable. The wedge shape has a shape complementary to the groove, i.e., optionally with sides angled by angle a discussed in connection to FIG. 4.

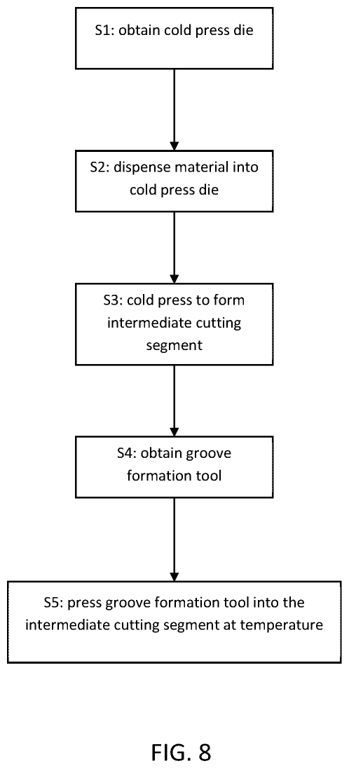

FIG. 8 is a flow chart that illustrates a production process for manufacturing a cutting segment 110 according to the description above. The method comprises obtaining S1 a cold press die, filling S2 the cold press die with metal powder and diamond material, applying pressure S3 to form an intermediate cutting segment blank, obtaining S4 a groove formation tool 700 as discussed herein, and producing S5 the cutting segment 110 by pressing the groove formation tool 700 into the green cutting segment at high temperature.

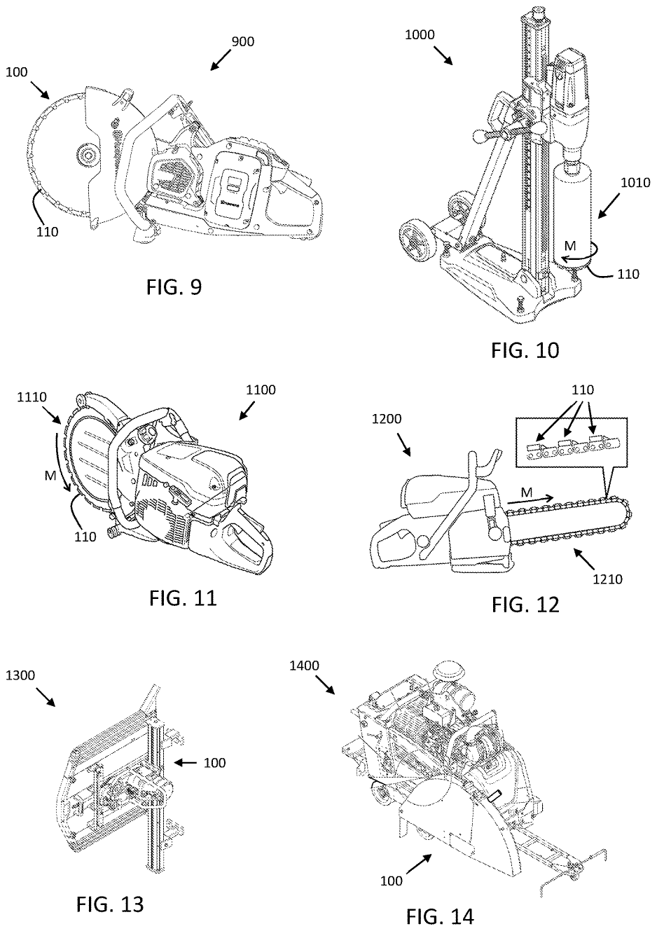

FIGS. 9-14 illustrate a variety of construction equipment comprising work tools where the cutting segments 100 can be used with advantage. FIG. 9 shows a cut-off tool 900 with a saw blade 100, FIG. 10 shows a core drill 1000 with a core drill bit 1010, FIG. 11 shows a ring saw with a cutting ring 1110, FIG. 12 illustrates a chain saw 1200 where the cutting segments 110 have been mounted onto the chain. FIGS. 13 and 14 show a wall saw 1300 and a floor saw 1400, both comprising saw blades 100.

1. A cutting segment for mounting onto a work tool to provide an abrasive operation by the work tool,
the cutting segment having first and second opposing side walls extending in an intended direction of motion of the cutting segment during the abrasive operation by the work tool,
wherein the side walls are joined by a top surface arranged to engage a work object during the abrasive operation, and
where a pre-formed groove in the top surface of the cutting segment extends in the intended direction of motion.

2. The cutting segment according to claim 1, where a depth of the pre-formed groove measured in a normal direction of a bottom surface of the groove is at least 0.75 mm, and preferably more than 1.0 mm at least in one place along the groove.

3. The cutting segment according to claim 1, where the pre-formed groove is a machined groove, a molded groove, or a pressed groove.

4. The cutting segment according to claim 1, wherein the pre-formed groove has longitudinal side walls extending in the intended direction of motion (M), where the longitudinal side walls of the pre-formed groove are arranged at an angle relative to the respective side wall of the cutting segment.

5. The cutting segment according to any previous claim 1, wherein the angle is between 30 degrees and 70 degrees, and preferably about 56 degrees.

6. The cutting segment according to any previous claim 1, wherein a width of the pre-formed groove measured orthogonally to the intended direction of motion decreases from between 3.3 mm and 4.3 mm and preferably 3.8 mm at the top of the pre-formed groove to between 0.5 mm and 1.5 mm and preferably 1.0 mm at the bottom of the pre-formed groove.

7. The cutting segment according to claim 1, wherein a ratio of the largest width of the pre-formed groove and a width the cutting segment is between 70% and 90%, and preferably about 80%.

8. The cutting segment according to claim 1, wherein a ratio of the largest depth of the pre-formed groove and the largest width of the pre-formed groove is between 30% and 50%, and preferably about 40%.

9. The cutting segment according to claim 1, wherein a ratio of the largest depth of the pre-formed groove and the largest width of the cutting segment is between 20% and 40%, and preferably about 30%.

10. The cutting segment according to claim 1, comprising diamond granules held fixedly in position by a bonding matrix.

11. The cutting segment according to claim 1, formed in at least three layers extending in direction of the side walls in the intended direction of motion and transversal to the top surface, where side layers forming the side walls comprise abrasive particles of a finer grit size compared to one or more layers interleaved between the side layers.

12. The cutting segment according to claim 11, wherein the abrasive particle grit size of the abrasive particles in the side layers corresponds to a mesh size of 40/45, and wherein the abrasive particle grit size of the abrasive particles in a layer interleaved between the side layers corresponds to a mesh size of 35/40.

13. The cutting segment according to claim 1, formed in at least three layers extending in direction of the side walls in the intended direction of motion and transversal to the top surface, wherein side layers forming the side walls comprise abrasive particles in a higher concentration compared to one or more layers interleaved between the side layers.

14. The cutting segment according to claim 13, wherein the volume percentage of abrasive particle concentration in the side layers is between 12.5-13.5%, and wherein the volume percentage of abrasive particle concentration in a layer interleaved between the side layers is between 11.5-12.5%.

15. The cutting segment according to claim 1, formed in at least three layers extending in direction of the side walls in the intended direction of motion and transversal to the top surface, where side layers forming the side walls comprise abrasive particles in a concentration that is at least 1.1 times higher than a concentration in one other layer, and preferably more than 1.7 times higher.

16. The cutting segment according to claim 1, formed in at least three layers extending in direction of the side walls in the intended direction of motion and transversal to the top surface, where side layers forming the side walls comprise abrasive particles of at least 5 mesh finer grit compared to one other layer.

17. The cutting segment according to claim 1, where the largest width of the pre-formed groove is smaller than the width of the cutting segment to form top surface side portions on either side of the pre-formed groove, where the top surface side portions are of arcuate form (R330) seen in direction of a side wall, while the bottom surface of the groove is a flat surface.

18. A saw blade, a core drill bit, a ring saw or a saw chain, comprising the cutting segment according to claim 1.

19. A groove formation tool arranged to form a groove having a wedge shape in graphite into the cutting segment according to claim 1.

20. (canceled)

21. (canceled)

22. A production method for producing a cutting segment, comprising
obtaining (S1) a cold press die,
filling (S2) the cold press die with metal powder and diamond material,
applying pressure (S3) to form an intermediate cutting segment blank,
obtaining (S4) a groove formation tool-according to claim 19, and
producing (S5) the cutting segment by pressing the groove formation tool into the green cutting segment at high temperature.
